(19) United States
(12) Patent Application Publication
(10) Pub. No.: US 2024/0028948 A1
(43) Pub. Date: Jan. 25, 2024

(54) SYSTEMS AND METHODS FOR EFFICIENTLY IMPLEMENTING HIERARCHIAL STATES IN MACHINE LEARNING MODELS USING REINFORCEMENT LEARNING

(71) Applicant: SUBSTRATE AI SA, Madrid (ES)

(72) Inventor: James Brennan WORTH, Aurora, CO (US)

(21) Appl. No.: 17/869,493

(22) Filed: Jul. 20, 2022

(51) Int. Cl. G06N 20/00

(52) U.S. Cl. CPC G06N 20/00

(57) ABSTRACT

Reinforcement learning can be applied to generate hierarchical states. Inputs associated with interactions of an agent with an environment are received, where interactions include states and actions that cause state changes. An indication of a target state to achieve is received. A sequence including a first, second, and third state is identified, where the agent can perform a first action to transition from the first to second state, and a second action to transition from the second state to the third state. A hierarchical state can be generated, where a third action transitions from the first state to the hierarchical state, and a fourth action transactions from the hierarchical state to the third state.

### FIELD

Hierarchical states can be identified, generated and efficiently implemented in virtual environments employing reinforcement learning to efficiently transition between states within the virtual environment.

### BACKGROUND

Virtual environments can include states and actions to transition between states. There can be a myriad of possible ways to transition from a start state to a desired end state in a virtual environment. Narrowly considering subsequent states/actions in a virtual environment can reduce generalizability of options discovered, while broadly considering subsequent states/actions in a virtual environment can be inefficient and computationally burdensome. Thus, a need exists for systems and methods to efficiently identify, generate, and implement hierarchical states in virtual environments that achieve a balance between being generalizable while remaining efficient.

### SUMMARY

In some embodiments, a method includes receiving inputs associated with interactions of an agent with an environment, the interactions including a group of states associated with the environment and a group of actions associated with each state from the group of states. An indication of a target state to be achieved by the agent in the environment is received. A state sequence including a first state, a second state, and a third state from the group of states such that the agent can perform a first action to implement a transition from the first state to the second state and a second action to implement a transition from the second state to the third state in a consecutive manner, is identified. A hierarchical state configured to be associated with (i) a third action implementing a transition from the first state to the hierarchical state, and (ii) a fourth action implementing a transition from the hierarchical state to the third state is generated. The first action and the second action form an option. A value associated with transition from the first state to the hierarchical state is set to be equal to a value combination that is a function of a value associated with the first action and a value associated with the second action, and a value associated with the transition from the hierarchical state to the third state is set to be equal to a maximum value associated with the third state.

In some embodiments, an apparatus includes a memory and a hardware processor operatively coupled to the memory. The hardware processor is configured to receive inputs associated with interactions of an agent with an environment, the interactions including a group of states associated with the environment and a group of actions associated with each state from the group of states. The hardware processor is further configured to receive an indication of a target state to be achieved by the agent in the environment by implementing a machine learning model. The hardware processor is further configured to identify a state sequence including a first state, a second state, and a third state from the group of states such that the agent can perform a first action to implement a transition from the first state to the second state and a second action to implement a transition from the second state to the third state in a consecutive manner. At least one of the first state, the second state, or the third state is a hierarchical state and associated with a primitive action. The hardware processor is further configured to determine an identifier associated with the hierarchical state. The hardware processor is further configured to search a dictionary associated with the machine learning model to determine whether the identifier associated with the hierarchical state is included in the dictionary. The hardware processor is further configured to add, based on the determination that the identifier associated with the hierarchical state is not included in the dictionary, the identifier associated with the hierarchical state to the dictionary to generate an updated dictionary. The hardware processor is further configured to store the updated dictionary.

In some embodiments, a non-transitory processor-readable medium stores code representing instructions to be executed by a processor. The instructions include code to cause the processor to receive data associated with interactions between a first agent and a first environment associated with a domain. The instructions further include code to cause the processor to receive information about a second environment associated with the domain, the information including a goal that is desired to be achieved in the second environment. The instructions further include code to cause the processor to implement, using a machine learning model, a second agent configured to interact with the second environment. The instructions further include code to cause the processor to identify, based on the data associated with the interactions between the first agent and the first environment, a set of actions configured to be performed by the second agent while the second agent interacts with the second environment. The instructions further include code to cause the processor to implement the second agent to perform an action from the set of actions. The action is configured to increase a likelihood of achieving the goal.

### BRIEF DESCRIPTION OF THE DRAWINGS

FIG. 1 is a schematic illustration of a management system, according to an embodiment.

FIG. 2 is a schematic representation of a compute device included in a management system, according to an embodiment.

FIG. 3 is a schematic representation of a management device included in a management system, according to an embodiment.

FIG. 4 is a schematic illustration of a flow of information within a management system to collectively manage the health status of livestock managed by multiple clients and the bioproduct quality of the managed livestock, according to an embodiment.

FIG. 5 is a schematic representation of an interaction between an agent included in a management system and an environment in which the agent takes action to implement a management process, according to an embodiment.

FIG. 6 is a schematic representation of states and state changes assumed by one or more agents implemented by a management system, according to an embodiment.

FIG. 7A is a schematic representation of a sequence of state changes from a start state to a termination state via actions performed by one or more agents implemented by a management system, according to an embodiment.

FIG. 7B is a schematic representation of a sequence of states, including a hierarchical state, interconnected via actions, according to an embodiment.

FIG. 7C is a schematic representation of a sequence of states, including two hierarchical states, interconnected via actions, according to an embodiment.

FIG. 8 is a flowchart describing a method for generating a hierarchical state, according to an embodiment.

FIG. 9 is a flowchart describing a method for including potential hierarchical states into a dictionary storing hierarchical states, according to an embodiment.

FIG. 10 is a flowchart describing a method for a second agent to perform actions in a second environment of a domain using previous knowledge of a first agent's interactions in a first environment of the domain, according to an embodiment.

### DETAILED DESCRIPTION

The systems and methods discussed herein are related to discovering hierarchical states and options as an agent interacts with a virtual environment. The generation of hierarchical states and options can accelerate the agent's ability to learn about its environment, while obtaining information that can be used for different future tasks. A transition of state/action pairs can provide an approach to discovering options by using hierarchical states to estimate the utility of learned options. Additionally, the techniques discussed herein do not suffer from vanishing option issues, where the length of options decreases to zero over time.

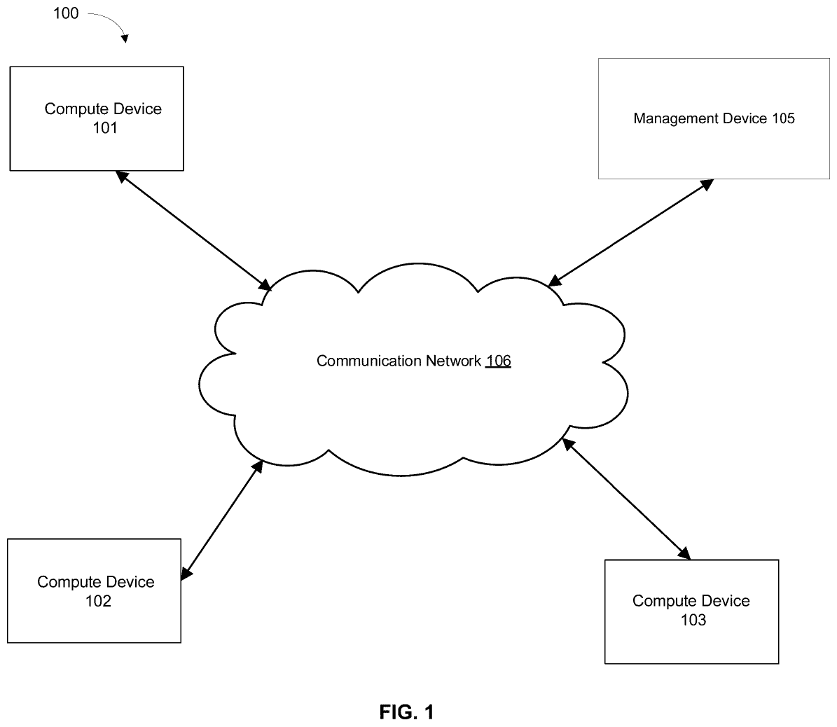

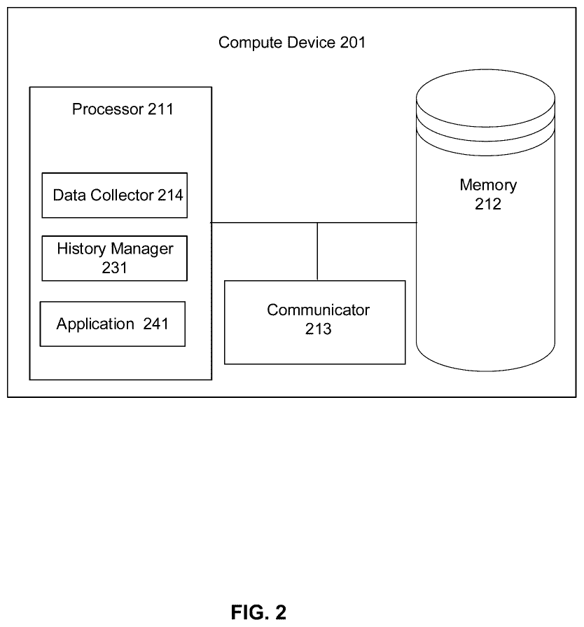

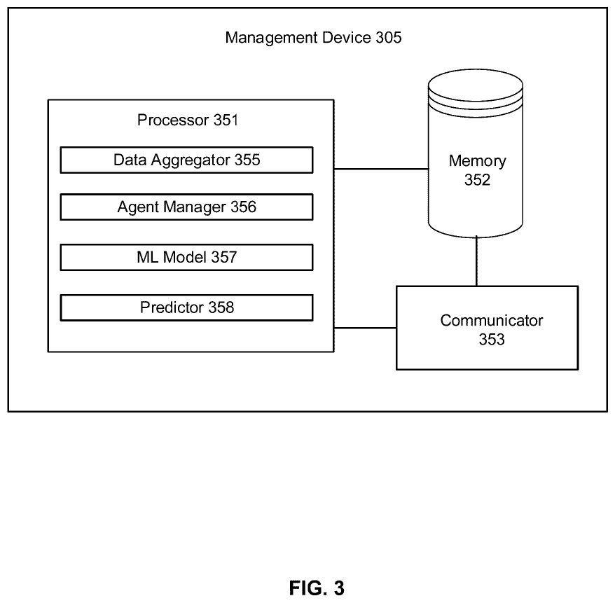

FIG. 1 is a schematic illustration of a management system 100. The management system 100 includes a management device 105 and compute devices 101, 102, 103, each of which are communicably coupled via a communication network 106. The compute devices 101, 102, and 103 in the management system 100 can each be any suitable hardware-based computing device and/or a multimedia device, such as, for example, a device, a desktop compute device, a smartphone, a tablet, a wearable device, a laptop and/or the like. In some implementations, the compute devices 101, 102, 103 can collect data about an environment and share that data with the management device 105 via the communication network 106. The management device 105 can aggregate the data collected and transmitted from the compute devices 101, 102, 103, manage one or more agents configured to interact in the environment based on the aggregated data, use machine learning (ML) models to make decisions based on the aggregated data, and make predictions based on outputs from the ML models. The management system 100 can be used to analyze initial states and cause actions within an environment via one or more agents to achieve a target state. Additional details related to the compute devices 101, 102, 103 are discussed with respect to FIG. 2, and additional details related to the management device 105 are discussed with respect to FIG. 3.

In some embodiments, the communication network 106 (also referred to as “the network”) can be any suitable communication network for transferring data, operating over public and/or private networks. For example the network 106 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the communication network 106 can be a wireless network such as, for example, a Wi-Fi or wireless local area network (“WLAN”), a wireless wide area network (“WWAN”), and/or a cellular network. In other instances, the communication network 106 can be a wired network such as, for example, an Ethernet network, a digital subscription line (“DSL”) network, a broadband network, and/or a fiber-optic network. In some instances, the network can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS)). The communications sent via the network 106 can be encrypted or unencrypted. In some instances, the communication network 106 can include multiple networks or subnetworks operatively coupled to one another by, for example, network bridges, routers, switches, gateways and/or the like (not shown).

FIG. 2 is a schematic block diagram of an example compute device 201 that can be a part of a system such as the management system 100 described above with reference to FIG. 1, according to an embodiment. The compute device 201 can be structurally and functionally similar to the compute devices 101-103 of the management system 100 illustrated in FIG. 1. The compute device 201 can be a hardware-based computing device and/or a multimedia device, such as, for example, a device, a desktop compute device, a smartphone, a tablet, a wearable device, a laptop and/or the like. The compute device 201 includes a processor 211, a memory 212 (e.g., including data storage), and a communicator 213.

The processor 211 can be, for example, a hardware based integrated circuit (IC) or any other suitable processing device configured to run and/or execute a set of instructions or code. For example, the processor 211 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 211 can be operatively coupled to the memory 212 through a system bus (for example, address bus, data bus and/or control bus).

The processor 211 can be configured to collect, record, log, document, and/or journal data associated with an environment. The processor 211 can include a data collector 214. The processor can optionally include a history manager 231, and an application 241. In some embodiments, the data collector 214, the history manager 231 and/or the application 241 can include a process, program, utility, or a part of a computer's operating system, in the form of code that can be stored in memory 212 and executed by the processor 211.

In some embodiments, each of the data collector 214, the history manager 231, and/or the application 241 can be software stored in the memory 212 and executed by processor 211. For example, each of the above-mentioned portions of the processor 211 can be code to cause the processor 211 to execute the data collector 214, the history manager 231, and/or the application 241. The code can be stored in the memory 212 and/or a hardware-based device such as, for example, an ASIC, an FPGA, a CPLD, a PLA, a PLC and/or the like. In some embodiments, each of the data collector 214, the history manager 231, and/or the application 241 can be hardware configured to perform the specific respective functions.

The data collector 214 can be configured to run as a background process and collect and/or log data related to an environment. In some instances, the data can be logged by personnel via the application 241 in the compute device 201. In some instances, the data can be automatically logged by sensors and/or input devices associated with the compute device 201 (not shown in FIG. 2). The sensors and/or input devices may be operated via the application 241 in the compute device 201. The sensors and/or input devices can be configured to automatically log data at specified time points or intervals and the data can be recorded by the data collector 214. In some implementations, the sensors and/or input devices can receive and log input from one or more users.

In some instances, the data collector 214 can store the information collected in any suitable form such as, for example, in the form of a text-based narrative of events, a tabulated sequence of events, data from sensors, and/or the like. In some instances, the data collector 214 can also analyze the data collected and store the results of the analysis in any suitable form such as, for example, in the form of event logs, or look-up tables, etc. The data collected by the data collector 214 and/or the results of analyses can be stored for any suitable period of time in the memory 212. In some instances, the data collector 214 can be further configured to send the collected and/or analyzed data, via the communicator 213, to a device that may be part of a system to which the compute device 201 is connected (e.g., the management device 105 of the management system 100 illustrated in FIG. 1). In some instances, the data collector 214 can be configured to send the collected and/or analyzed data automatically (e.g., at specified time points, or periodically with a predetermined frequency of communication), in response to receiving an instruction from a user to send the analyzed data, and/or in response to a query from the management device for the analyzed data.

In some embodiments, the history manager 231 of the processor 211 can be configured to maintain logs or schedules associated with a history of handling or management an environment. The history manager 231 can also be configured to maintain a log of information related to the sequence of events (e.g., interventions).

The memory 212 of the compute device 201 can be, for example, a random-access memory (RAM), a memory buffer, a hard drive, a read-only memory (ROM), an erasable programmable read-only memory (EPROM), and/or the like. The memory 212 can be configured to store any data collected by the data collector 214, or data processed by the history manager 231, and/or the application 241. In some instances, the memory 212 can store, for example, one or more software programs and/or code that can include instructions to cause the processor 211 to perform one or more processes, functions, and/or the like (e.g., the data collector 214, the history manager 231 and/or the application 241). In some embodiments, the memory 212 can include extendable storage units that can be added and used incrementally. In some implementations, the memory 212 can be a portable memory (for example, a flash drive, a portable hard disk, and/or the like) that can be operatively coupled to the processor 211. In some instances, the memory can be remotely operatively coupled with the compute device. For example, a remote database device can serve as a memory and be operatively coupled to the compute device.

The communicator 213 can be a hardware device operatively coupled to the processor 211 and memory 212 and/or software stored in the memory 212 executed by the processor 211. The communicator 213 can be, for example, a network interface card (NIC), a Wi-Fi™ module, a Bluetooth® module and/or any other suitable wired and/or wireless communication device. Furthermore, the communicator 213 can include a switch, a router, a hub and/or any other network device. The communicator 213 can be configured to connect the compute device 201 to a communication network (such as the communication network 106 shown in FIG. 1). In some instances, the communicator 213 can be configured to connect to a communication network such as, for example, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

In some instances, the communicator 213 can facilitate receiving and/or transmitting data or files through a communication network (e.g., the communication network 106 in the management system 100 of FIG. 1). In some instances, received data and/or a received file can be processed by the processor 211 and/or stored in the memory 212 as described in further detail herein. In some instances, as described previously, the communicator 213 can be configured to send data collected and/or processed by the data collector 214 and/or history manager 231 to a device of a system (e.g., management device 105) to which the compute device 201 is connected.

Returning to FIG. 1, the compute devices 101-103 that are connected to management system 100 can be configured to communicate with a management device 105 via the communication network 106. FIG. 3 is a schematic representation of a management device 305 that is part of a system. The management device 305 can be structurally and/or functionally similar to the management device 105 of the management system 100 illustrated in FIG. 1. The management device 305 includes a communicator 353, a memory 352, and a processor 351.

Similar to the communicator 213 within compute device 201 of FIG. 2, the communicator 353 of the management device 305 can be a hardware device operatively coupled to the processor 351 and the memory 352 and/or software stored in the device memory 352 executed by the processor 351. The communicator 353 can be, for example, a network interface card (NIC), a Wi-Fi™ module, a Bluetooth® module and/or any other suitable wired and/or wireless communication device. Furthermore, the communicator 353 can include a switch, a router, a hub and/or any other network device. The communicator 353 can be configured to connect the management device 305 to a communication network (such as the communication network 106 shown in FIG. 1). In some instances, the communicator 353 can be configured to connect to a communication network such as, for example, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

The memory 352 of the management device 305 can be a random-access memory (RAM), a memory buffer, a hard drive, a read-only memory (ROM), an erasable programmable read-only memory (EPROM), and/or the like. The memory 352 can store, for example, one or more software modules and/or code that can include instructions to cause the device processor 351 to perform one or more processes, functions, and/or the like. In some implementations, the memory 352 can be a portable memory (e.g., a flash drive, a portable hard disk, and/or the like) that can be operatively coupled to the device processor 351. In some instances, the memory 352 can be remotely operatively coupled with the device. For example, the memory 352 can be a remote database device operatively coupled to the device and its components and/or modules.

The processor 351 can be a hardware based integrated circuit (IC) or any other suitable processing device configured to run and/or execute a set of instructions or code. For example, the processor 351 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 351 is operatively coupled to the memory 352 through a system bus (e.g., address bus, data bus and/or control bus). The processor 351 is operatively coupled with the communicator 353 through a suitable connection or device as described in further detail.

The processor 352 can be configured to include and/or execute several components, units and/or instructions that may be configured to perform several functions, as described in further detail herein. The components can be hardware-based components (e.g., an integrated circuit (IC) or any other suitable processing device configured to run and/or execute a set of instructions or code) or software-based components (executed by the processor 352), or a combination of the two. As illustrated in FIG. 3, the processor 351 includes a data aggregator 355, an agent manager 356, an ML model 357, and a predictor 358.

The data aggregator 355 in the processor 351 can be configured to receive communications from compute devices connected to the device 305 through suitable communication networks (e.g., compute devices 101-103 connected to the device 105 via the communication network 106 in the management system 100 in FIG. 1). The data aggregator 355 is configured to receive, from the compute devices, information collected and/or generated by the one or more data collectors in the compute devices (e.g., data collector 214 of compute device 201 shown and described with respect to FIG. 2).

The data aggregator 355 is further configured to receive data associated with history managers in the compute devices (e.g., history manager 231 on compute device 201 in FIG. 2). In some instances, the data aggregator 355 can be configured to receive a record of information related to a sequence of events (e.g., a schedule of interventions). In some implementations, the data aggregator 355 can receive the information sent by the compute devices at one or more specified time points or intervals. In some implementations, the data aggregator 355 can be configured to query the compute devices at one or more specified time points or time intervals to receive the data or information in response to the query. In some implementations, the data aggregator 355 can be configured to send queries and/or receive data/information from compute devices automatically and/or in response to a user generated action (e.g., user activated transmission of a query via a software user interface).

In some instances, the data aggregator 355 can be further configured to receive, analyze, and/or store communications from compute devices regarding any suitable information related to an environment. The data aggregator 355 can receive, analyze, and/or store information associated with target aspects (e.g., goals) associated with the environment. The information received from a compute device can include, for example, one or more threshold values related to a target property associated with a goal, such as a quality, quantity, and/or desired rate. The data aggregator 355, in some instances, can also be configured to receive analytical reports based on analysis of an environment.

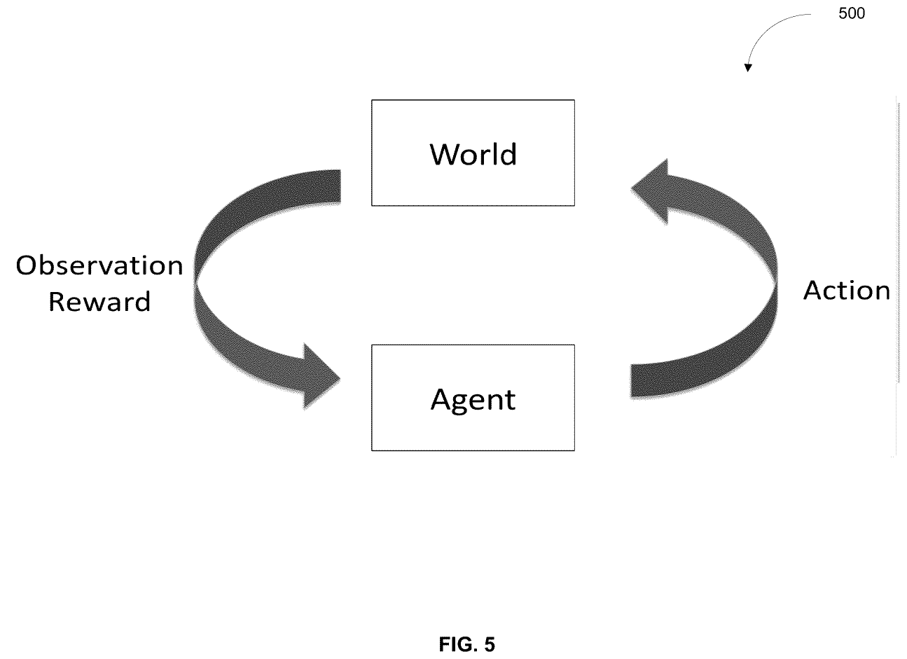

The processor 351 includes an agent manager 356 that can be configured to generate and/or manage one or more agents configured to interact in an environment and/or implement machine learning. An agent can refer to an autonomous entity that performs actions in an environment or world that is modeled or set up according to a set of states or conditions and configured to react or respond to agent actions. An environment or world can be defined as a state/action space that an agent can perceive, act in, and receive a reward signal regarding the quality of its action in a cyclical manner (e.g., illustrated in FIG. 5). A system can define a dictionary of agents including definitions of characteristics of agents, their capabilities, expected behavior, parameters and/or hyperparameters controlling agent behaviors, etc. A system can define a dictionary of actions available to agents. In some implementations, the actions available to an agent can depend and/or vary based on the environment or world in which the agent acts. In some implementations, an agent manager 356 can use measurements obtained from analysis of items to define reward signals.

In some implementations, an environment or world can be defined to include state/action pairs. Through this cyclical interaction, agents can be configured to learn to automatically interact within a world intelligently without the need of a controller (e.g., a programmer) defining every action sequence that the agent takes.

In an example implementation, agent-world interactions can include the following steps. An agent observes an input state. An action is determined by a decision-making function or policy (which can be implemented by an ML model 358). The action is performed. The agent receives a reward or reinforcement from the environment in response to the action being performed. Information about the reward given for that state/action pair is recorded. The agent can be configured to learn based on the recorded history of state/action pair and the associated reward. Each state/action pair can be associated with a value using a value function under a specific policy. Value functions can be state-action pair functions that estimate how favorable a particular action can be at a given state, or what the return for that action is expected to be. In some implementations, the value of a state (s) under a policy (p) can be designated Vp(s). A value of taking an action (a) when at state (s) under the policy (p) can be designated Qp(s,a). The goal of the MANAGEMENT device 305 can then be estimating these value functions for a particular policy. The estimated value functions can then be used to determine sequences of actions that can be chosen in an effective and/or accurate manner such that each action is chosen to provide an outcome that improves and/or maximizes total reward possible, after being at a given state.

As an example, the agent manager 356 can define a virtual environment that includes the virtual management of a specified cohort of virtual animals of a managed livestock (e.g., goats). The virtual environment can be developed using data aggregated by the data aggregator 355. The managed livestock can be raised to produce a specified bioproduct (e.g., milk). The agent manager 356 can define agents that perform actions that simulate events in the real world that may impact the management of the cohort of animals of the managed livestock. For example, the agent manager 356 can define actions that can simulate providing a specified feed blend to individual animals in a cohort of animals, providing a medicinal treatment and/or a dietary supplement to individual animals in the cohort of animals, measuring a health status and/or a property associated health status of each animal in the cohort of animals, achieving a desired target of collectively improving a health status and a quality of bioproduct, or reaching a target property and/or health status associated with each animal in the cohort of animals, obtaining a production of a specified quantity and/or quality of a bioproduct (e.g., a volume of milk, a measured value of a protein content in milk, and/or the like), etc.

In some implementations, each agent can be associated with a state from a set of states that the agent can assume. Each agent can be configured to perform an action from a set of actions. The agent manager 356 can be configured to mediate an agent to perform an action, the result of which transitions the agent from a first state to a second state. In some instances, a transition of an agent from a first state to a second state can be associated with a reward. The actions of an agent can be directed towards achieving specified goals. The actions of agents can be defined based on observations of states of the environment obtained through data aggregated by the data aggregator 356 from compute devices or sources related to the environment (e.g., from sensors in a real-world environment). In some instances, the actions of the agents can inform actions to be performed via actors (e.g., human or machine actors or actuators). In some instances, the agent manager 356 can generate and/or maintain several agents. The agents can be included in groups defined by specified goals. In some instances, the agent manager 356 can be configured to maintain a hierarchy of agents that includes agents defined to perform specified tasks and sub-agents under control of some of the agents.

In some instances, agent manager 356 can mediate and/or control agents to be configured to learn from past actions to modify future behavior. In some implementations, the agent manager 356 can mediate and/or control agents to learn by implementing principles of reinforcement learning. For example, the agents can be directed to perform actions, receive indications of rewards and associate the rewards to the performed actions. Such agents can then modify and/or retain specific actions based on the rewards that are associated with each action, to achieve a specified goal by a process directed to increase the number of rewards. In some instances, such agents can operate in what is initially an unknown environment and can become more knowledgeable and/or competent in acting in that environment with time and experience. In some implementations, agents can be configured to learn and/or use knowledge to modify actions to achieve specified goals.

In some embodiments, the agent manager 356 can configure the agents to learn to update or modify actions based on implementation of one or more machine learning models. In some embodiments, the agent manager 356 can configure the agents to learn to update or modify actions based on principles of reinforcement learning. In some such embodiments, the agents can be configured to update and/or modify actions based on a reinforcement learning algorithm implemented by the ML model 357, described in further detail herein.

In some implementations, the agent manager 356 can generate, based on data obtained from the data aggregator 355, a set of input vectors that can be provided to the ML model 357 to generate an output that determines an action of an agent. In some implementations, the agent manager 356 can generate input vectors based on inputs obtained by the data aggregator 355 including data received from compute devices and/or other sources associated with an environment (e.g., sensors).

The ML model 357, according to some embodiments, can employ an ML algorithm to optimize and/or increase a property, such as increasing efficiency, reaching a minimum threshold value, decreasing cost, etc. In some instances, for example, the ML model 357 can represent or simulate a virtualized world using various properties associated with an environment, and can use reward signals derived based on tasks defined to achieve target results.

In some instances, the ML model 357 can implement a reinforcement learning algorithm to determine actions that can be undertaken by agents in a virtualized environment to arrive at predictions to increase a probability or likelihood of achieving a specified goal. The ML model 357 can be configured such that it receives input vectors and generates an output based on the input vectors. In some instances, the ML model 357 can be configured to generate an output indicating strategy to achieve a desired target status within a specific time period. The ML model 357 can be implemented using any suitable model (e.g., a statistical model, a mathematical model, a neural network model, and/or the like). The ML model 357 can be configured to receive inputs and based on the inputs generate outputs.

The ML model 357 can implement any suitable form of learning such as, for example, supervised learning, unsupervised learning and/or reinforcement learning. The ML model 357 can be implemented using any suitable modeling tools including statistical models, mathematical models, decision trees, random forests, neural networks, etc. In some embodiments, the ML model 357 can implement one or more learning algorithms. Some example learning algorithms that can be implemented by the ML model can include Markov Decision Processes (MDPs), Temporal Difference (TD) Learning, Advantage Actor-Critic (A2C), Asynchronous Advantage Actor-Critic (A3C), Deep Q Networks (DQNs), Deep Deterministic Policy Gradient (DDPG),Evolution Strategies (ES) and/or the like. The learning scheme implemented can be based on the specific application of the task. In some instances, the ML model 357 can implement Meta-Learning, Automated Machine Learning and/or Self-Learning systems based on the suitability to the task.

The ML model 357 can incorporate the occurrence of rewards and the associated inputs, outputs, agents, actions, states, and/or state transitions in the scheme of learning. The ML model 357 can be configured to implement learning rules or learning algorithms such that upon receiving inputs indicating a desired goal or trajectory that is similar or related to a goal or trajectory that was achieved or attempted to be achieved in the past, the ML model 357 can use the history of events including inputs, outputs, agents, actions, state transitions, and/or rewards to devise an efficient strategy based on past knowledge to arrive at the solution more effectively.

While an ML model 357 is shown as included in the management device 305, in some embodiments, the ML model can be omitted and the management device 305 can implement a model free reinforcement learning algorithm to implement agents and their actions.

In some implementations, the ML model 357 and/or the agent manager 356 can implement hierarchical learning (e.g., hierarchical reinforcement learning) using multiple agents undertaking multi-agent tasks to achieve a specified goal. For example, a task can be decomposed into sub-tasks and assigned to agents and/or sub-agents to be performed in a partially or completely independent and/or coordinated manner. In some implementations, the agents can be part of a hierarchy of agents and coordination skills among agents can be learned using joint actions at higher level(s) of the hierarchy.

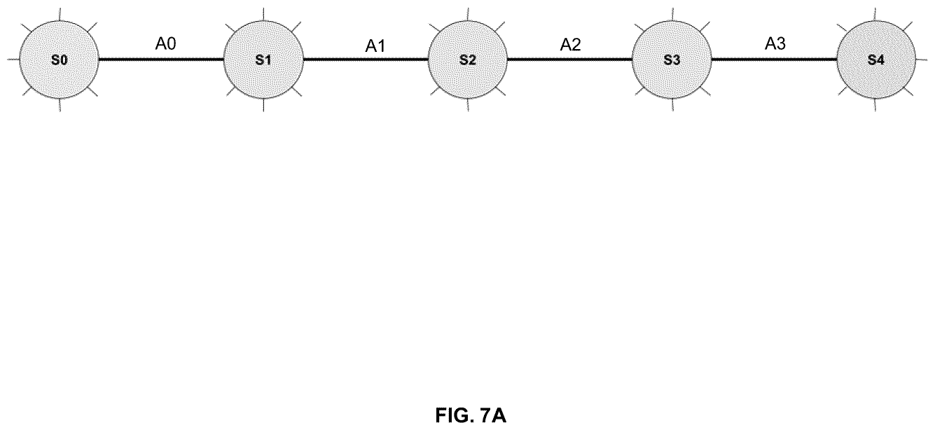

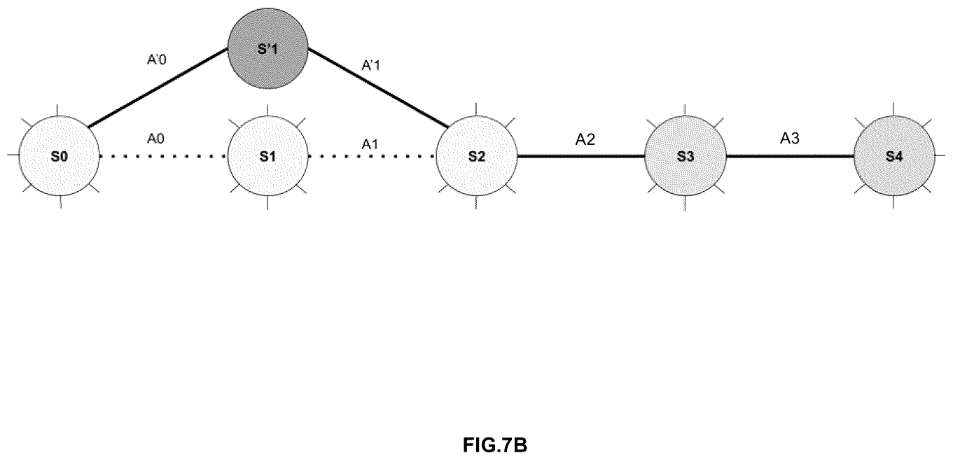

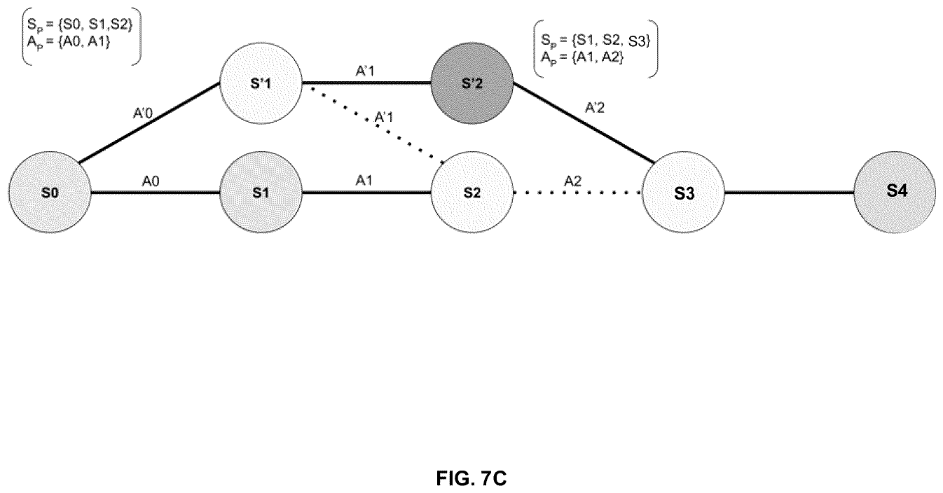

In some implementations, the ML model 357 and/or the agent manager 356 can implement temporal abstractions in learning and developing strategies to accomplish a task towards a specified goal. Temporal abstractions can be abstract representations or generalizations of behaviors that are used to perform tasks or subtasks through creation and/or definition of action sequences that can be executed in new and/or novel contexts. Temporal abstractions can be implemented using any suitable strategy including an options framework, bottleneck option learning, hierarchies of abstract machines and/or MaxQ methods. Additional details related to temporal abstractions and hierarchical states are discussed with respect to FIGS. 7A-7C and 8-10.

The processor 351 further includes a predictor 358 configured to receive outputs from the ML model 357 and based on the outputs make predictions that can be tested in the real world. For example, the predictor 358 can receive outputs of ML model 357 and generate a prediction of achieving a specified target goal. In some embodiments, goals can include a target balance between two or more of these aspects and/or a collective improvement in two or more aspects. The predictor 358 can generate a prediction based on outputs of ML model 357 that a goal may be achieved within a specified duration of time following the implementation of an action. In some implementations, the predictor 358 can receive outputs of ML model 357 and generate a prediction of a projected amount of time needed to perform an action to meet a specified target. In some implementations, the predictor 358 can receive outputs of ML model 357 and generate a prediction of a projected amount of time that an action should be performed to meet a specified target.

In some implementations, the predictor 358 can provide several predictions that can be used to recommend, select and/or identify a strategy to be implemented in the real world. In some instances, the output of the predictor 358 can be used to determine profitability and quote estimation. In some instances, the output of the predictor 358 can be used to provide an estimated cost to complete a task.

In use, the management device 305 can receive inputs from one or more compute devices and/or remote sources using a data aggregator 355. The management device 305 can implement virtualized agents acting within a virtualized world or environment, using an agent manager 356 and/or an ML model 357. In some implementations, the environment can be defined in a form of a Markov decision process. For example, the environment can be modeled to include a set of environment and/or agent states (S), a set of actions (A) of the agent, and a probability of transition at a discreet time point (t) from a first state (S1) to a second state (S2), the transition being associated with an action (a).

In some implementations, the agents and/or the world can be developed based on one or more inputs or modified by one or more user inputs. The management device 305 can provide aggregated information to the ML model 357. In some embodiments, the agent(s) can be part of the ML model 357. In some embodiments, the ML model 357 can implement the environment in which the agent(s) are configured to act. In some instances, the management device 305 can receive an indication of a changes that have occurred in an environment. In some instances, the management device 305 can receive an indication of a recommendation. The recommendation can be closely aligned with a prior prediction or recommendation generated by the management device 305. The management device 305 can then provide the input associated with a positive change and/or indication of a recommendation from another source which is aligned with a recommendation of the management device 305 in the form of a reward such that the ML model 357 can learn the positive association of a previously recommended strategy.

In some implementations, the management device 305 can predict or generate estimated rewards that can be used as predictions to be compared with reward signals received based on a state of a world or environment. The management device 305 can be configured to learn and/or update the ML model 357 and/or the agent and its behavior based on a comparison between the estimated reward and an actual reward received from the world. Over time and/or over a course of implementation of the virtual environment/agents, the management device 305 can generate an output based on the information received. The output of the ML model 357 can be used by a predictor 358 to generate a prediction of an outcome or an event or a recommendation of an event to achieve a desired goal.

While the management device 305 is described to have one each of a data aggregator, an agent manager, an ML model, and a predictor, in some embodiments, a device similar to the device 305 can be configured with several instances of the above-mentioned units, components, and/or modules. For example, in some embodiments, the device may include several data aggregators associated with one or more compute devices or groups of compute devices. As another example, the device may include several agent managers generating and operating multiple agents as described in further detail herein. As yet another example, in some embodiments, the device may include several ML models and/or several predictors assigned to perform specified computations and/or predictions.

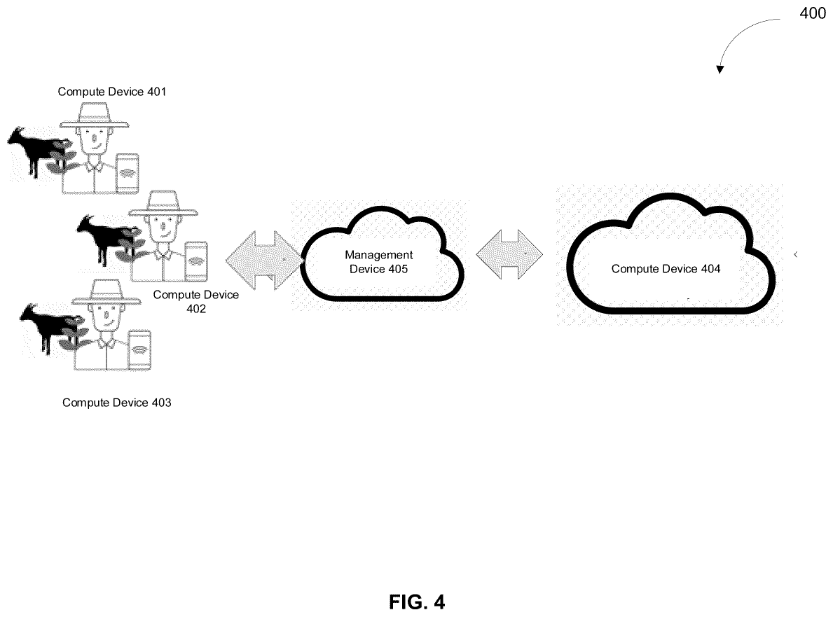

As an example, FIG. 4 is an illustration of a flow of information in a management system 400, according to an implementation. The management system 400 can be substantially similar to the management system 100 in structure and/or function. In the illustrated implementation, the management system 400 can include a management device 405 (similar to management device 105, 305), compute devices 401, 402, and 403 (similar to compute device 101, 102, 103, 201) associated with farmers managing livestock including goats producing milk, and a compute device 404 associated with an animal's health specialist (e.g., veterinarian). The management system 400 can include customers associated compute devices (not shown) that can be producers of products derived from milk (e.g., cheese products, yogurt-based products, etc.) or producers of milk.

The management device 405 can receive inputs from the compute devices 401-403 providing data related to handling of animals and their upkeep. In some instances, the management device 405 can receive input from the compute devices 401-403 indicating a target quality of bioproduct and/or a target property associated with health status that is desired by the farmers. The management device 405 can receive any number of inputs. For example, the management device 405 can receive additional inputs (not shown in FIG. 4) from other compute devices (not shown) indicating a target health status, reproductive property or property associated with production of a bioproduct (e.g., a target reproductive state of an individual animal, a target reproduction rate in a cohort of animals that is higher than a threshold, a target quantity/quality of bioproduct higher than a threshold, etc.) for example. The management device 405 can be configured to generate a strategy to achieve the desired goals associated with each farmer. In some implementations, the management system 400 can be configured to generate a cost estimate and/or a quote for sale of a specified or desired quantity of bioproduct (i.e., milk) with the desired target quality for each customer, and send information associated with the cost estimate to the respective compute devices 401-403.

The management device 405 can send to and/or receive inputs from the compute device 404 associated with an animal health specialist (e.g., a veterinarian). In some implementations, the management device 405 can send feeding data and/or other animal handling data (e.g., data received from compute devices 401-403 associated with farmers and/or end-use customers) to the compute device 404. In some implementations, the management system 405 can send an indication of a target health status, target reproductive property associated with health status, and/or a target quality of a property of bioproduct that is of interest (e.g., data received from compute devices 401-403). In some implementations, the management device 405 can receive from the compute device 404 associated with an animal health specialist an indication of a recommendation of feed schedule and/or feed blend to be provided to individual animals in a cohort. In some implementations, the management device 405 can receive information and/or a recommendation related to medicinal treatments and/or dietary supplements to be provided to individual animals in a cohort to increase a likelihood of achieving a target health status and/or reproductive property. In some implementations, the management device 405 can be configured to over time learn a pattern of information or recommendations and events associated with the information or recommendation provided by the compute device 404 associated with the animal health specialist such that the management device 405 can provide inputs in place of and/or in addition to the information or recommendations from the animal health specialist.

The management device can provide based on computations carried out and/or based on inputs received from the compute devices (e.g., devices 401, 402, 403, 404) and/or sources (not shown) a recommendation of feed, feed blend, medicinal treatment and/or dietary supplement to be provided to individual animals to achieve a specific target goal. In some instances, a medicine and/or a dietary supplement can be included in a feed blend or be a part of a feed schedule. In some instances, a management system 400 can recommend aspects of animal health other than feeding. For example, a management system 400 can recommend a schedule of animal handling including a schedule for exercise, a schedule for sleep, a schedule for light cycle, a schedule for temperature, a schedule for any other suitable activity or state, a schedule for sanitation/hygiene, and/or the like. In some implementations, the management device 405 can send the feeding schedule and/or other animal handling schedule to the compute devices 401-403. In some implementations, the management system 405 can send an indication of an estimated property of health status or an estimated reproductive property (e.g., estimated reproductive rate) that may be obtained at a specified period of time if the animals were maintained in a particular regimen of feed schedule and/or dietary supplement/medicinal treatment schedule. In some implementations, the management system 405 can send an indication of an estimated cost associated with achieving a target population of animals and/or a target quantity/quality of a property of bioproduct that may be obtained at a specified period of time if the animals were maintained in a particular regimen of feed schedule and/or dietary/medicinal supplement schedule. In some implementations, the management device 405 can achieve any of the aforementioned tasks via an options framework using hierarchical states, which is discussed in further detail herein. Additional details related to the management system 400 are also discussed in patent application Ser. No. 17/488,706, titled “METHODS AND APPARATUS TO ADAPTIVELY OPTIMIZE FEED BLEND AND MEDICINAL SELECTION USING MACHINE LEARNING TO OPTIMIZE ANIMAL MILK PRODUCTION AND HEALTH”, the contents of which are incorporated by reference in its entirety herein.

FIG. 5 is a schematic representation of an interaction between an environment and an agent included in a management system 500, according to an embodiment. The management system 500 can be substantially similar in structure and/or function to the management system 100 and/or management system 400 described above. The management system 500 includes a management device (not shown in FIG. 5) that can be substantially similar to the management devices 105, 305, and/or 405 described herein. The management system 500 can include compute devices (not shown in FIG. 5) similar to compute devices 101-103, 201, 401-403, and/or 406, described herein.

The management system 500 includes a virtualized agent and a virtualized environment or world that the agent can act in using actions that impact a state of the world. The world can be associated with a set of states and the agent can be associated with a set of potential actions that can impact the state of the world. The world and/or a change in state of the world in turn can impact the agent in the form of an observation of a reward that can be implemented by the management system 500. The management system 500 can be configured such that the interactions between the world and the agent via actions and/or observations of rewards within the management system 500 can be triggered and/or executed automatically. For example, a management device within the management system 500 that executes the interactions between the world and the agent can be configured to automatically receive inputs from sources or compute devices, and based on the inputs automatically trigger agent actions, state transitions in the world, and/or implementations of reward.

In some embodiments, the disclosed systems and/or methods can include implementation of cognitive learning in the learning of agent-world interactions. In some implementations, a system can be implemented based on a hierarchical cognitive architecture as described, and/or using a hierarchical learning algorithm by a management device (e.g., management device 105 and/or 305) or a compute device (e.g., compute device 101-103, and/or 201,) as described herein. A hierarchical reinforcement learning algorithm can be configured to decompose or break up a reinforcement learning problem or task into a hierarchy of sub-problems or sub-tasks. For example, higher-level parent-tasks in the hierarchy can invoke lower-level child tasks as if they were primitive actions. Some or all of the sub-problems or sub-tasks can in turn be reinforcement learning problems. In some instances, a system as described herein can include an agent can include many capabilities and/or processes including: Temporal Abstraction, Repertoire Learning, Emotion Based Reasoning, Goal Learning, Attention Learning, Action Affordances, Model Auto-Tuning, Adaptive Lookahead, Imagination with Synthetic State Generation, Multi-Objective Learning, Working Memory System, and/or the like. In some embodiments, one or more of the above listed capabilities and/or processes can be implemented as follows.

(i) Repertoire Learning—Options learning can create and/or define non-hierarchical behavior sequences. By implementing repertoire learning hierarchical sequences of options can be built that can allow and/or include increasingly complicated agent behaviors.

(ii) Emotion Based Reasoning—Emotions in biological organisms can play a significant role in strategy selection and reduction of state-spaces improving the quality of decisions.

(iii) Goal Learning—Goal learning can be a part of the hierarchical learning algorithm. Goal learning can be configured to support the decision-making process by selecting sub-goals for the agent. Such a scheme can be used by sub-models to select action types and state features that may be relevant to their respective function.

(iv) Attention Learning—Attention learning can be included as a part of the implementation of hierarchical learning and can be responsible for selecting the features that are important to the agent performing its task.

(v) Action Affordances—Similar to Attention learning, affordances can provide the agent with a selection of action types that the agent can perform within a context. A model implementing action affordances can reduce the agent's error in behavior execution.

(vi) RL Model Auto-Tuning—This feature can be used to support the agent to operate in diverse contexts by changing contexts via auto-tuning altering the way in which a model is implemented.

(vii) Adaptive Lookahead—Using a self-attention mechanism that uses prior experience to control current actions/behavior, adaptive lookahead can automate the agent search through a state space depending on the agent's emotive state and/or knowledge of the environment. Adaptive lookahead can improve the agent's computational needs by targeting search to higher value and understood state spaces.

(viii) Imagination with Synthetic State Generation—Synthetic state generation can facilitate agent learning through the creation of candidate options that can be reused within an environment with the agent not having to experience the trajectory first-hand. Additionally, synthetic or imagined trajectories including synthetic states can allow the agent to improve its attentional skills by testing selection implementation of different feature masks such as attention masks.

(ix) Multi-Objective Learning—Many real-world problems can possess multiple and possibly conflicting reward signals that can vary from task to task. In this implementation, the agent can use a self-directed model to select different reward signals to be used within a specific context and sub-goal.

(x) Working Memory System—The Working Memory System (WMS), can be configured to maintain active memory sequences and candidate behaviors for execution by the agent. Controlled by the executive model (described in further detail herein), WMS facilitates adaptive behavior by supporting planning, behavior composition and reward assignment.

These capabilities and/or processes can be used to build systems that function with 98% less training data while realizing superior long-term performance.

In some embodiments, the systems and/or methods described herein can be implemented using quantum computing technology. In some embodiments, systems and/or methods can be used to implement, among other strategies, Temporal Abstraction, Hierarchical Learning, Synthetic State and Trajectory Generation (Imagination), and Adaptive Lookahead.

Temporal Abstraction is a concept in machine learning related to learning a generalization of sequential decision making. A system implementing a Temporal Abstraction System (TAS) can use any suitable strategy including an options framework, bottleneck option learning, hierarchies of abstract machines and/or MaxQ methods. In some implementations, using the options framework, a system can provide a general-purpose solution to learning temporal abstractions and support an agent's ability to build reusable skills. The TAS can improve an agent's ability to successfully act in states that the agent has not previously experienced before. As an example, an agent can receive a specific combination of inputs indicating a sequence of states and can make a prediction of a trajectory of states and/or actions that may be different from its previous experience but effectively chosen based on implementing TAS. For example, an agent operating in a management system simulating a world involving the management of livestock can receive, at a first time, inputs related to a health status of a cohort of animals on a predefined feed. The agent can be configured to interact with the world such that the system can predict a progress in health status and/or a yield of bioproduct, even if the prediction is different from the agent's past experience, based on implementing TAS. The prediction can include a recommendation of feed selection or feed schedule to increase a likelihood of achieving a predicted result (e.g., health status/yield). Another example includes agents operating in financial trading models that can use TAS to implement superior trading system logic. Another example includes agents operating in natural language processing (NLP) models that can use TAS to implement superior NLP logic.

The TAS can support generalization of agent behavior. The TAS can also support automatic model tuning where agents/agent actions can be used to automatically adjust agent hyperparameters that affect learning and environment behaviors/interactions. For example, in some embodiments of a system, a set of parameters can be defined as hyperparameters. Some parameters involved in reinforcement learning include parameters used in Q-value update such as a learning rate α, a discount factor associated with weight of future rewards γ, and a parameter to balance between exploration and exploitation by choosing a threshold value ε (e.g., allows reduction in the amount of weight that states in the far future have on a decision). These parameters can be implemented as hyperparameters that can be defined to be associated with an agent such that a specified change in a hyperparameter can impact the performance of the model and/or the agent in a specified manner. In some instances, a specified change in a hyperparameter can, for example, modify an agent from a practiced behavior to an exploratory behavior. An agent and/or a model can learn a set of dependencies associated with hyperparameters such that a hyperparameter can be automatically tuned or modified in predefined degrees to alter agent behavior and/or model behavior.

In such an autotuning system, developers and/or associated devices no longer have to iterate on finding model configurations with good convergence. The model can support contextually adaptive hyperparameter values depending on how much the agent is aware about the current context and/or the environment's changing reward signal. Working in concert, the agent learns reusable strategies that are context sensitive allowing the agent to support adaptive behavior over time while enabling the agent to balance explorative/exploitative behaviors.

As described previously, embodiments of a system described herein can implement temporal abstraction in the virtualization of a world and/or agents to implement temporally extended courses of action, for example, to determine a recommended protocol of animal handling to meet demands on production of bioproducts based on end-use. Disclosed herein is a method to recursively build, improve and/or optimize temporal abstractions (also referred to as options) and hierarchical Q-Learning states to facilitate learning and action planning of reinforcement learning based machine learning agents.

In some implementations, a system can build and define a library or dictionary of options that can be used and/or reused partially and/or fully at any suitable time in any suitable manner. For example, skills and hierarchical states that can be applied to learning can enable a system to learn to respond to new stimuli in a sophisticated manner that can be comparable or competitive to human learning abilities. The disclosed methods and apparatus provide an approach to automatically construct options and/or automatically construct hierarchical states efficiently while controlling a rate or progress and/or growth of a model through the selection of salient features. When applied to reinforcement learning agents the disclosed methods and apparatus efficiently and generally solves problems related to implementing actions over temporally extended courses and improves learning rate and ability to interact in complex state/action spaces.

In some implementations, the machine learning model can be configured to automatically receive inputs that can serve as reward signals and adaptively update, based on a difference metric, the temporal abstraction to generate the second output, a third output, and so on.

A temporal abstraction can be implemented by generating and/or using options that include sequences of states and/or sequences of actions. The implementation of options can be based on generating and adopting reusable action sequences that can be applied within known and unknown contexts of the world implemented by a management system.

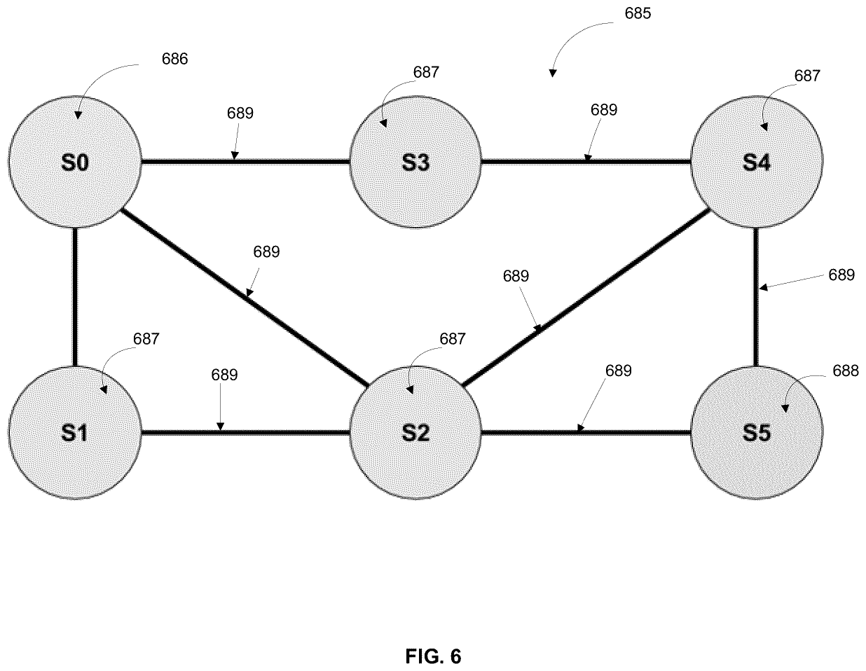

An example option 685 is illustrated in FIG. 6. An option can be defined by a set of initiation states (S0) 686, action sequences 689 involving intermediary states (S1, S2, S3, S4) 687, and/or a termination probability associated with a termination state (S5) 688. When an option 685 is to be executed, the agent can be configured to first determine its current state and if any of the available options offers to have a start state that is similar to its current state. If there is a positive identification of an option that includes a start state the same as its current state, the agent can then execute the sequence of predefined actions for the new states included in the option until the agent reaches the termination state or the termination probability condition is set to true. For example, the agent can identify start state (S0) 686 to be similar to a current state and identify the option 685 as a selection to be executed. In some instances, the option 685 can then be executed by the agent starting at the start state 686 and progressing through intermediary states S1-S2-S5, via actions indicated by the lines joining the respective states, to reach the termination state S5 688. In some instances, the agent can execute the option 685 by starting at the start state S0 686 and progressing through state S2 alone, or through states S2-S4, or through states S3-S4 indicated by lines representing actions, to reach the termination state S5 688. At state S5 the option terminates and the agent proceeds to select another action or option as dictated by agent behavior designed by an agent manager and/or by outputs from an ML model.

In some instances, systems and methods described herein can implement hierarchical states in reinforcement learning that can play a role in improving agent learning rate and/or in the development of long-term action plans. In some instances, with an increase in complexity of a task (e.g., increase in number of alternative solutions, increase in dimensionality of variable to be considered, etc.) the trajectory to the solution can become intractable due to exponentially increasing complexity of agent actions due to an increase in the number of states in the system. In some implementations, the management system can implement hierarchical states, which decrease the size of a state space associated with an management system. This implementation of hierarchical states and the resulting decrease in state space can lead to an exponential decrease in a time for learning in agents.

In some embodiments, a system can be configured that can learn options and generate and use hierarchical states effectively using a recursive execution of a process associated with a Bellman Optimization method as described herein. The recursive process can be configured to converge on optimal and/or improved values over a period of time. The method and/or system can allow for the agent to select improved and/or optimal policies (e.g., actions resulting in state transitions) in known and unknown environments and update their quality values over time. In some instances, the method and/or system can treat options and hierarchical states as functionally dependent at creation and can allow for the merging of existing options and hierarchical states to build new state and action compositions. Over time, as the agent explores the state space, the algorithm can generate new hierarchical states and composition hierarchical states as the agent performs numerous trajectories through the state/action space.

FIG. 7A is an illustration of states and actions associated with interactions of an agent (or agents) with an environment, according to an embodiment. In some implementations, the techniques discussed with respect to FIGS. 7A-7C can be implemented by a management device (e.g., management device 105 of FIG. 1 and/or management device 305 of FIG. 3). The management device can be used to cause one or more agents to perform actions that cause a transition from a start state to a termination state. For example, a data aggregator (e.g., data aggregator 355) can aggregate data associated with an environment of an agent collected at/received from a compute device (e.g., compute device 101, 102, 103, 201), and an ML model (e.g., ML model 357) can use that data to generate an output that determines an action of the agent. Then, an agent manager (e.g., agent manager 356) can use the output from the ML model to cause the agent to perform the determined action and cause a transition to a new state. FIG. 7A can includes a start state S0, intermediary states S1, S2, S3, and a termination state S4. The termination state S4 can indicate a target state (i.e., goal state) to be achieved by the agent. As can be seen, each state has eight potential routes (represented by the eight different lines protruding from each of the five states) that are linked to other states (not shown) that can be traversed and/or reached via respective actions. In the scenario shown in FIG. 7A, when conditions for the start state S0 are achieved, one or more agents can cause state changes from the start state S0 to the intermediary state S1 via an action A0, from the intermediary state S1 to the intermediary state S2 via an action A1, from the intermediary state S2 to the intermediary state S3 via an action A2, and from the intermediary state S3 to the termination state S4 via an action A3 (e.g., where the actions can caused by the agent manager 356). However, before each action from a first state to a subsequent second state is performed, eight potential routes to different states can be considered (e.g., by ML model 357). As previously mentioned, when it comes to transitioning from a start state to a termination state, although exploring alternative routes can be desirable, exploring too many alternative routes can have drawbacks (e.g., inefficient). As the number of states and actions increases, the number of potential routes from a start state to a termination state also increases exponentially. The systems and methods discussed herein improve agent planning by the creation and/or definition of connected states with significantly reduced action spaces (i.e., hierarchical states). These hierarchical states can be tagged (e.g., with a unique identifier) and accessed efficiently through hierarchical state specific searches. The process of combining the state-action space (via hierarchical states) can significantly reduce the searchable state space, thereby allowing the agent to quickly identify optimal and/or improved policies.

For example, FIG. 7B shows an illustration of a scenario similar to that of FIG. 7A, but including a hierarchical state S′1 generated by a management system (e.g., management system of FIG. 1 and/or management device 305 of FIG. 3), according to an embodiment. FIG. 7B includes a start state S0, intermediary states S1, S2, S3, hierarchical state S′1, and termination state S4. The hierarchical state S′1 is a composition of states S0, S1, and S2, with a primitive action sequence of A0 and A1.

To build and/or generate a hierarchical state (e.g., hierarchical state S′1), a management system can first identify two consecutive state/action transitions through the world/environment (i.e., a state sequence including a first state, a second state, and a third state such that an agent can perform a first action to implement a transition from the first state to the second state and a second action to implement a transition from the second state to the third state in a consecutive manner). The management system can perform a sequence of verification steps, including verifying that (1) the identified state/action transitions have Q (s,a) values (also referred to herein as Q-values) above a predetermined threshold (e.g., zero), such as each Q-value being above the predetermined threshold, or a value combination (i.e., output) that is a function of the Q-values being above the predetermined threshold (e.g., sum, average, weighted average, difference, product, quotient, etc.), where the Q-values can be values associated with an estimated reward for taking a specific action at a specific state under a predefined policy, as defined previously, (2) the identified state/action sequence is non-cyclical, (3) the value combination is at a value that is above a threshold value of interest (e.g., a threshold value set by a programmer/user), and/or (4) the transition sequence does not include a transition cycle between the start state to the termination state (i.e., S0 to S4). Following the above steps, if positively verified (i.e., determined to be generalizable), the management system can continue to the next step. Otherwise the management system can return to identifying two new consecutive state action transitions. If positively verified, the management system can create and/or define a new hierarchical state S′ (e.g., state S′1 as shown in FIG. 7B). This new state can be associated with new actions (e.g., actions A′0, A′1 as shown in FIG. 7B), and the new actions can be associated with respective Q-values. Although some discussions herein refer to Q-values, it can be appreciated that in some implementations, any value (i.e., reinforcement learning value) can be used instead of or in addition to Q-values, such as an advantage value, learned value, computed value, value function, and/or the like.

Referring to FIG. 7B, action A′0 can transition start state S0 to hierarchical state S′1, and action A′1 can transition from the hierarchical state S′1 to the intermediate state S2, thereby forming an option. The Q-value of action A′0 can be set to be the equal to the Q-value of action A0, while the Q-value of action A′1 is set to be equal to the max Q-value associated with state S2. In some implementations, the Q-value associated with the hierarchical state S′1 is associated with a reward expectation greater than that of the intermediate state S1.

Unlike the scenario from FIG. 7A, where transitioning from the start state S0 to the intermediate state S2 required considering eight potential routes at the start state S0 and eight potential routes at the intermediate state S1 prior to arriving at the intermediate state S2, the scenario shown in FIG. 7B enables a transition from the start state S0 to the intermediate state S2 using the hierarchical state S′1, which only has two potential routes to consider. Considering less routes can decrease computational burden, thereby enabling decisions to be made more efficiently, and as a result, a target state can be achieved more efficiently. As can be appreciated, this can have many positive implications, since a target state can be achieved faster and more efficiently from a given start state.

The above techniques additionally support merging of existing hierarchical states with new action trajectories. This can simplify the process of building and maintaining hierarchical states no matter how complex the environment in a general and fully automatic algorithm. Thus, it can be appreciated that any number of hierarchical states can be created and used. Additionally, hierarchical states can have actions transitioning to and/or from other hierarchical states and/or non-hierarchical states. Additionally, hierarchical states can be associated with any number of actions (e.g., 2, 3, 4, 5, etc.). FIG. 7C is an illustration of another scenario similar to that of FIG. 7B, but with an additional hierarchical state S′2. In FIG. 7C, the hierarchical state S′2 is a composition of states S1, S2, and S3 with a primitive action sequence of A1 and A2.

A similar technique used to generate hierarchical state S′1 and actions A′0, A′1 described with respect to FIG. 7B can be applied to generate hierarchical state S′2 and actions A′1, A′2. In the scenario shown in FIG. 7B, upon identifying a first state/action transition (e.g., hierarchical state S′1 and action A′1) and second state/action transition (e.g., intermediate state S2 and action A2), the management system can verify that (1) the first and second state/action transitions have non-zero Q-values and/or any other function of the Q-values (e.g., sum, average, weighted average, difference, product, quotient, etc.) is within a predetermined acceptable range (e.g., non-zero, above a threshold, etc.), and (2) that the first and second state/action transitions are non-cyclic. In other implementations, additional and/or alternative verification steps can be used (e.g., amount of potential actions to consider, potential reward signal, etc.). If the verification does not pass, the management system can continue to identify state/action transitions. If the verification passes, as shown in FIG. 7C, the hierarchical state S′2 can be generated, where the action A′1 now transitions from the hierarchical state S′1 to the hierarchical state S′2, and an action A′2 transitions from the hierarchical state S′2 to the intermediate state S3. The Q-value of A′1 is set equal to the Q-value of A1, and the Q-value of A′2 is set equal to the maximum Q-value associated with S3. In some implementations, hierarchical states can be associated with more than two actions. For example, rather than action A′1 transitioning from hierarchical state S′1 to the hierarchical state S′2 at FIG. 7C, action A′1 can remain transitioning between hierarchical state S′1 and intermediate state S2, while an additional action (e.g., A″1) transitions from hierarchical state S′1 to the hierarchical state S′2. Thus, in an alternative version of FIG. 7C, hierarchical state S′1 can be associated with action A′0, action A′1 transitioning to intermediate state S2, and an additional action transitioning to hierarchical state S′2.

For both scenarios discussed with respect to FIGS. 7B and 7C, a management system can extract state primitives and action primitives from standard and hierarchical state transitions. Based on the extracted information, the management system can create and/or define a new hierarchical action from start state S0 in sequence to a new hierarchical state (e.g., action A′0) and add the hierarchical action to a new hierarchical action associated with the start state S0. The management system can create and/or define another new hierarchical action from the new hierarchical state (e.g., action A′1 from state S′1) to an intermediary state (e.g., S2) or a last state in sequence (e.g., S4 in FIGS. 7B and 7C) and add the newly created and/or defined hierarchical action to an action list associated with the last state. The management system can then add the new hierarchical state to Q Model states. This new hierarchical state can be reached using normal planning and its Q-value can be updated using the current system logic.

In some instances, a management system can be configured to implement and/or learn to implement state deletion. In some instances, a management system can consider combining multiple options to create and/or define a repertoire behavior from option action sequences that were previously generated by a temporal abstraction algorithm, also referred to herein as repertoires. The management system can be configured to learn to merge the two hierarchical states to form a single option that combines the options associated with the hierarchical states and build a new hierarchical state. In some instances, the management system can merge two options by selecting a set of hierarchical states and merging the action primitives to construct a new option. This merging process of hierarchical states creates more abstract state hierarchical states and larger options.

In some implementations, to generate an option, the management system can initiate an induction cycle to create and/or define a state name S′x (e.g., x=1, 2, . . . n) from action sequences by using action sequences extracted from hierarchical state algorithms. The management system can identify an action A′x associated with the state S′x. The management system can check that action A′x is not in a preexisting dictionary of options and that a sum of action Q-values associated the action sequence including A′x is above a threshold value of interest. If the verification steps are indicated to not be true, the system exits from the induction cycle. If the verification steps are indicated to be true (i.e., A′x is not in the dictionary of options and the sum of action Q-values associated with the action sequence including A′x is above a threshold value) the management system can continue. If true, the management system can create and/or define an option with a start state from hierarchical state induction sequence as initial initiation state or start state.

A method to construct hierarchical states can be implemented using reinforcement learning. The method can be associated with agents, and can use pairwise state/action transitions to recursively optimize and/or improve action values using the Bellman Optimality Principle. In some implementations, the method can use a Q-value threshold to determine if a new hierarchical state is to be added to the model (e.g., reinforcement model). In some implementations, the method can include generating hierarchical states in a recursive manner from other hierarchical states.

In some implementations, generating a hierarchical state can include computing a Q-value (or other value) associated with a first action implementing a transition from a first state to a second state, and a Q-value (or other value) associated with a second action implementing a transition from the second state to a third state. Generating the hierarchical state can further include verifying that a value combination that is a function of Q-values (or other values) associated with the actions (i.e., the first action and the second action) have a value above a predetermined threshold. Furthermore, as a management device (e.g., management device of FIG. 1 and/or management device 305 of FIG. 3) receives data associated with a performance of an agent in an environment (e.g., from compute device 102, 103, 104), the predetermined threshold value can be modified (e.g., increased or decreased). For example, if options are infrequently generated by an agent, the predetermined threshold value can decrease to cause additional hierarchical states to be created and/or defined. As another example, if an agent generates a number of hierarchical states greater than a predetermined limit (e.g., 5, 10, 25, 50, 100, 250, 500, 1000, etc.), the predetermined threshold value can increase to reduce the number of created and/or defined hierarchical states.

A method to construct options/skills can be implemented using reinforcement learning. The method can be associated with agents, and can use pairwise state/action transitions to recursively optimize action values using the Bellman Optimality Principle. The method can use a Q-value threshold to determine if a new option/skill is to be added to the reinforcement model's options dictionary. In some implementations, the method can include generating hierarchical states associated with options/skills in a recursive manner from other hierarchical states.

In some implementations, the management system can additionally support automatic merging of previously generated hierarchical states with new action trajectories or action sequences in a manner that can be consistent with an existing sequence of states/actions. This functionality can simplify a process of building and maintaining hierarchical states no matter how complex an environment is in a general and fully automatic algorithm. The disclosed management systems and/or methods can thus reuse existing Q-Learning model insertion, update and deletion mechanisms to manage hierarchical states. By using model update mechanisms of Q-Learning, selection of hierarchical states can help convergence to optimal and/or improved values over time according to the Bellman Optimality Principle. In some such implementations, the management system thus combines sample efficient methods for the generation and merging of hierarchical states with mathematically mature methods to ensure that the quality of actions and options executed over time converge to optimal and/or improved values.

In some embodiments, the disclosed management systems and/or methods can include implementation of cognitive or hierarchical learning in the learning of agent-world interactions. In some implementations, as described herein, a management system can be configured to operate as a Hierarchical Learning System (HLS) that can implement a hierarchical learning algorithm that uses a recursively optimized collection of models (e.g., reinforcement learning models) to support different aspects of agent learning.

In some embodiments, interactions between an agent and a first environment associated with a domain can be received. These interactions can then be used by the same agent and/or a different agent in a different environment associated with the same domain. This can be possible, in part, because the agent in the different environment is not limited to knowledge about only lower level (i.e., more narrow) states/actions, but also has access to knowledge about higher level (i.e. less narrow) states/actions due to the hierarchical states.

Examples of domains can include agricultural technology, financial trading, and/or natural language processing (NLP). For instance, options related to deciding which stocks to buy in order to maximize a financial portfolio can also be used, as least partially, to decide which bonds to buy in order to maximize a financial portfolio. As another example, options related to determining if a first set of text includes an intended meaning can be used, at least partially, to decide if a second set of text different that the first set includes that intended meaning and/or a different intended meaning similar to that intended meaning.

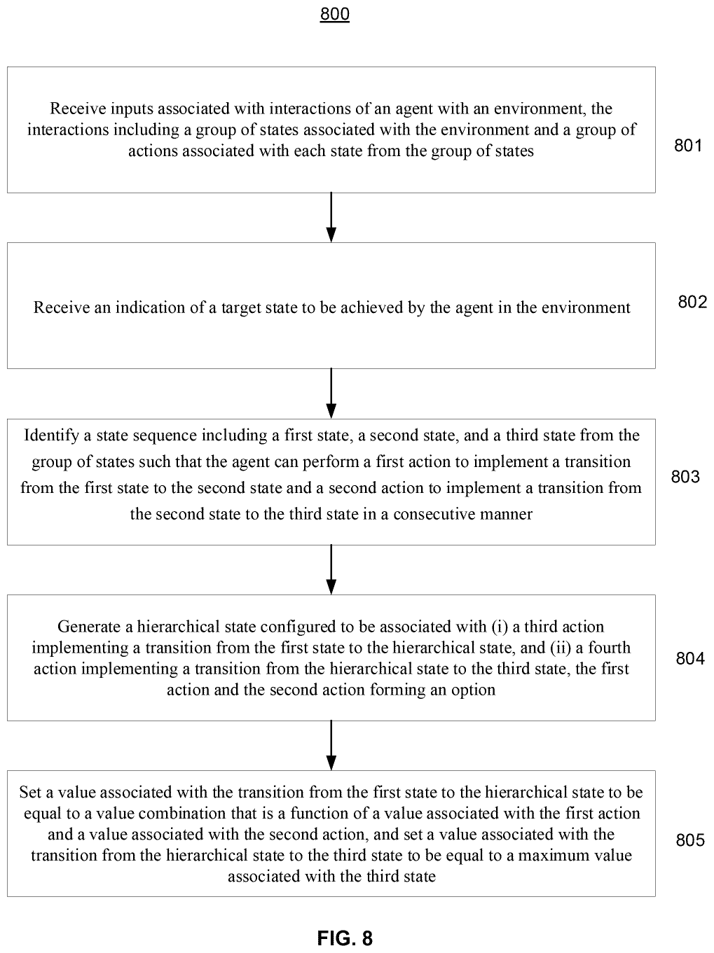

FIG. 8 is a flowchart of a method 800, according to an embodiment. In some implementations, the method 800 can be performed by a processor (e.g., processor 351) of a management device (e.g., management device of FIG. 1 and/or management device 305 of FIG. 3). The method 800 includes, at 801, receiving (e.g., at management device 105 and from compute device 101, 102, and/or 103) inputs (e.g., sensor data) associated with interactions of an agent with an environment, the interactions including a group of states associated with the environment and a group of actions associated with each state from the group of states.

At 802, receive an indication of a target state to be achieved by the agent in the environment. Examples of target states can be associated with a specific quality, quantity, speed, efficiency, and/or value.

At 803, identify a state sequence including a first state, a second state, and a third state from the group of states such that the agent can perform a first action to implement a transition from the first state to the second state, and a second action to implement a transition from the second state to the third state in a consecutive manner. In this context, being consecutive can refer to going from the first state to the third state via two actions (i.e., a first action from the first state to the second state, and a second action from the second state to the third state). The first and second action are the same in some implementations. In other implementations, the first and second action are not the same. The first state, the second state, and the third state can be different states.

At 804, generate a (new) hierarchical state configured to be associated with (i) a third action implementing a transition from the first state to the hierarchical state, and (ii) a fourth action implementing a transition from the hierarchical state to the third state, the first action and the second action forming an option. The first, second, third, and fourth actions can be the same, different, or a combination thereof. In some implementations, the third and/or fourth action are hierarchical actions. In some implementations, the hierarchical state is associated with a combination of values from primitive states (i.e., non-hierarchical states). Said similarly, the hierarchical state's actions include a combination that is a function of actions from primitive states. In some implementations, the first, hierarchical, and third state can be combined to generate a sequence of states associated with the third action and the fourth action. This sequence of states can form an option sequence.

At 805, set a value (e.g., Q-value) associated with the transition from the first state to the hierarchical state to be equal to a value combination (e.g., sum, average, weighted average, difference, product, etc.) that is a function of a value associated with the first action and a value associated with the second action, and set a value associated with the transition from the hierarchical state to the third state to be equal to a maximum value associated with the third state. In some implementations, the maximum value associated with the third state is the maximum value of an action connected to the third state.

In some implementations, method 800 can further include computing the value combination, which can be performed after 804 and prior to 805.

In some implementations, method 800 can further include verifying that the state sequence is non-cyclical. In some implementations, method 800 can further include verifying that the value combination has a non-zero value and/or a value above a predetermined threshold (e.g., greater than zero). In some implementations, method 800 can further include verifying that the value associated with the first action has a value above a first predetermined threshold (e.g., greater than zero), and verifying that the value associated with the second action has a value above a second predetermined threshold (e.g., greater than zero), where the first and second predetermined thresholds can be the same or can be different. Verifying (1) that the state sequence is non-cyclical, and (2) that the value combination has a value above the predetermined threshold and/or that the value associated with the first action and the value associated with the second action are above their respective threshold values can be performed after 803 and before 804, and in some implementations, can act as a check. Similarly stated, in some implementations, 804 is only performed if (1) the state sequence is non-cyclical, and (2) the value combination is above a predetermined threshold and/or the Q-value associated with the first action and the Q-value associated with the second action are above their respective predetermined threshold values. If the check fails, the method returns to 803. In some implementations, additional data associated with a performance of the agent in the environment can be received/analyzed, and the predetermined threshold and/or first and/or second predetermined threshold value can be modified (e.g., increased, decreased) based on the analysis.

In some implementations, the state sequence including the first, second, and third state can be determined to be generalizable, where the first, second, and third state are determined to be generalizable in response to verifying that (1) the identified state/action transitions have values above a predetermined threshold, (2) the identified state/action sequence is non-cyclical, (3) that a sum of values associated with the identified state/action transitions is at a percent value (e.g., 1%, 5%, 10%, 50%, etc.) or absolute value that is above a threshold value of interest (e.g., a threshold value set by a programmer/user), and/or (4) a transition sequence does not include a transition cycle from the start state to the termination state. The new hierarchical state configured to form the option can be discovered, where the option is configured to implement a transition from the first state to the third state with increased efficiency compared to the state sequence by reducing the number of actions that the agent can take between the first and third state. The option can also be configured to implement a transition from the first action to the second action in a reusable sequence. In some implementations, for example, the second state is associated with a first number of potential decisions to implement a transition from the first state to the third state, and the hierarchical state is associated with a second number of potential decisions to implement the transition from the first state to the third state, where the hierarchical state is discovered, a determination is made that the option does not exists in an options dictionary, and the option is formed in response to determining that the option does not exist in the options dictionary.

In some implementations, a (different) second hierarchical state can be formed at some point after 805 that is associated with a fifth action and a sixth action. In some implementations, the fifth action and the sixth action can transition this hierarchical state to and/or from any of the current states (i.e., first, second, third, and/or previous hierarchical state). A similar process used to apply the previous hierarchical state (i.e., in 804) can be used to generate the second hierarchical state.

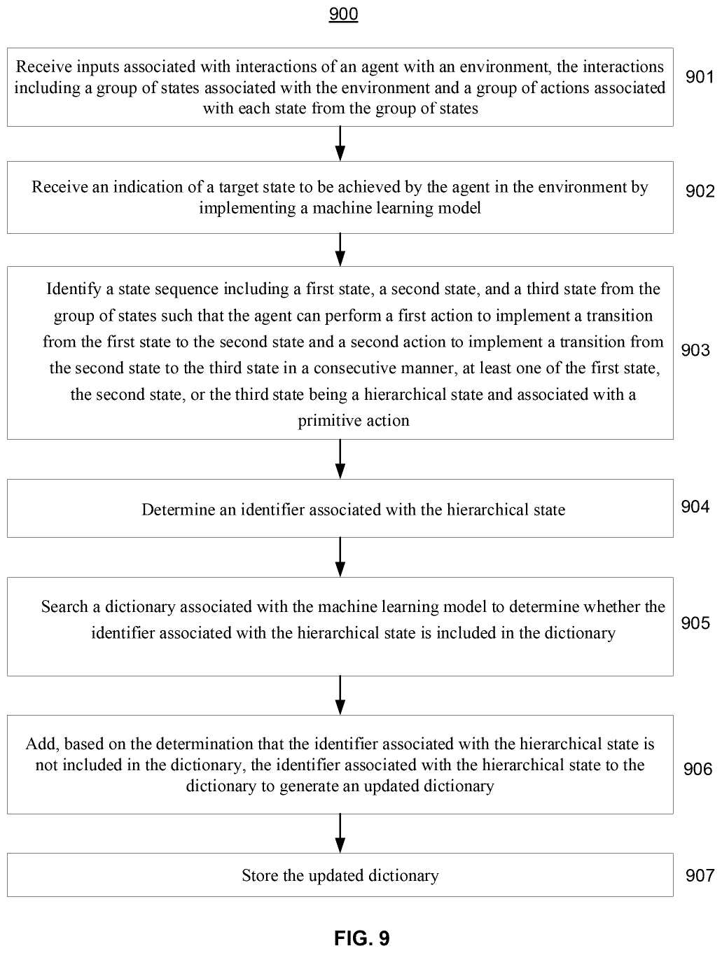

FIG. 9 is a flowchart of a method 900, according to an embodiment. In some implementations, the method 900 can be performed by a processor (e.g., processor 351 shown in FIG. 3) of a management device (e.g., management device of FIG. 1 and/or management device 305 of FIG. 3). Method 900 includes, at 901, receiving inputs associated with interactions of an agent with an environment, the interactions including a group of states associated with the environment and a group of actions associated with each state from the group of states. At 902, receive an indication of a target state to be achieved by the agent in the environment by implementing a machine learning model (e.g., ML model 357). At 903, identify a state sequence including a first state, a second state, and a third state from the group of states such that the agent can perform a first action to implement a transition from the first state to the second state and a second action to implement a transition from the second state to the third state in a consecutive manner, at least one of the first state, the second state, or the third state being a hierarchical state and associated with a primitive action.

At 904, determine an identifier associated with the hierarchical state. This can include, for instance, using an action primitive sequence extracted from the hierarchical state to create a state hash name. Said similarly, an action primitive sequence (e.g., {A0, A1}, {A1, A2}) can be extracted from the hierarchical state (e.g., S′1, S′2), and a hashing algorithm can be applied to the action primitive sequence to generate the identifier.

At 905, search a dictionary (e.g., stored in memory 352) associated with the machine learning model to determine whether the identifier associated with the hierarchical state is included in the dictionary. The dictionary can include one or more options that each use a hierarchical state to transition between one or more states. Each of the one or more options in the dictionary can include a hierarchical state, where each hierarchical state can be associated with a unique identifier (e.g., state hash name). Thus, if the identifier determined at 904 is not already in the dictionary, it can be determined that an option associated with the hierarchical state is not included in the dictionary (and vice versa). Note that, if the identifier is a state hash name, each state hash name in the dictionary (including, potentially, the state hash name identified at 904) would have been generated using a common hashing algorithm.

At 906, add, based on the determination that the identifier associated with the hierarchical state is not included in the dictionary, the identifier associated with the hierarchical state to the dictionary to generate an updated dictionary. At 907, store the updated dictionary. That way, if a subsequent potential hierarchical state is identified, the updated dictionary can be searched to determine if an option associated with that subsequent potential hierarchical state should be generated. If the identifier associated with the hierarchical state is determined to already be in the dictionary at 905, 906 and 907 can be skipped. The dictionary can be desirable because options included in the dictionary can be applied by an agent(s) in other environments without having to regenerate hierarchical states/options.

In some implementations of method 900, the hierarchical state is associated with fewer actions and/or potential actions than a state that is not a hierarchical state (i.e., the first, second, and/or third state). In some implementations of method 900, the second state is associated with a first future reward expectation, and the hierarchical state is associated with a second future reward expectation that is greater that the first future reward expectation (e.g., higher Q-value, more efficient, faster results, better results, etc.). In some implementations, the second state is associated with a first number of potential actions and the hierarchical state is associated with a second number of potential actions less than the first number of potential actions. In some implementations, the hierarchical state is generated by merging two or more states (e.g., merging two states, merging three states, etc.), where the merged states can be hierarchical states, non-hierarchical states, or a combination of both. In some implementations of method 900, the second state is the hierarchical state, the hierarchical state is an abstraction of a fourth state, the hierarchical state is associated with fewer actions than the fourth state, a third action implements a transition from the first state to the fourth state, a fourth action implements a transition from the fourth state to the third state, the first action is associated with a value combination that is a function of a value associated with the third action and a value associated with the fourth action, the second action is associated with a maximum value associated with the third state.

In some implementations of method 900, the machine learning model used at 902 can be configured to implement interactions between the agent and the environment. The machine learning model can implement a first set of interactions between the agent and the environment to transition from the first state to the third state via the second state, where the first set of interactions can be associated with a first reward signal. Before, after, or at the same time, the machine learning model can implement a second set of interactions (e.g., different than the first set of interaction) between the agent and the environment to transition from the first state to the third state via the hierarchical state, where the second set of interactions is associated with a second reward signal. Thereafter, the identifier associated with the hierarchical state determined at 904 can be added to the dictionary at 906 if and/or only if the second reward signal is greater than the first reward signal.

In some implementations, the machine learning model used at 902 is associated with a set of hyperparameters used to implement interactions between the agent and the environment. Upon implementing a set of interactions between the agent and the environment to transition from the first state to the third state via the hierarchical state, where the set of interactions is associated with a reward signal, the hyperparameters can be automatically adjusted (i.e., without human intervention) in response to receiving the reward signal.

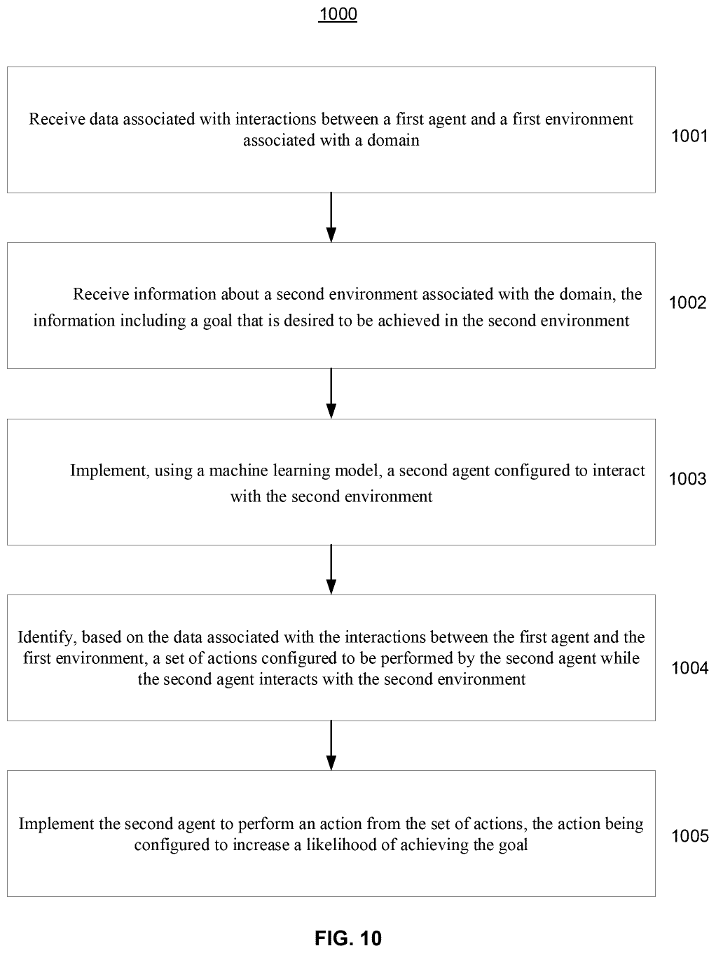

FIG. 10 is a flowchart of a method 1000, according to an embodiment. In some implementations, the method 1000 can be performed by a processor (e.g., processor 351) of a management device (e.g., management device 105, 305). The method 1000 includes, at 1001, receive data associated with interactions between a first agent and a first environment associated with a domain. Examples of domains can include a financial trading domain, agriculture domain, NLP domain, education domain, fitness domain, and/or the like.

At 1002, receive information about a second environment associated with the domain, the information including a goal that is desired to be achieved in the second environment. In some implementations, the second environment is the same as the first environment. In some implementations, the second environment is different than the first environment.

At 1003, implement, using a machine learning model, a second agent configured to interact with the second environment. In some implementations, the second agent is the same as the first agent. In some implementations, the second agent is different than the first agent. In some implementations, the second agent perceives the second environment to transition from a first state to a second state, where the first state and/or the second state is configured to increase the likelihood of achieving a goal and/or increasing an efficiency in computation associated with achieving the goal.

At 1004, identify, based on the data associated with the interactions between the first agent and the first environment, a set of actions configured to be performed by the second agent while the second agent interacts with the second environment. At 1005, implement the second agent to perform an action from the set of actions, the action being configured to increase a likelihood of achieving the goal.

In some implementations, the goal at 1005 is a second goal, the first environment is implemented to perform a first task to achieve a first goal in the domain, and the second environment is implemented to perform a second task to achieve the second goal in the domain. In some implementations, the first goal and the second goal are the same, while in other implementations, the first goal and the second goal are different.

In some implementations, each of methods 800, 900, 1000 and/or portions thereof can be performed automatically and in real time. Similarly stated, human input/direction is not needed to cause a step to be performed. In some implementations, human input/direction can be incorporated.

As can be appreciated, the systems and methods discussed herein can be used in a myriad of scenarios. For example, a school district can use a management system for improving their students' academic performance. The management system can use agents (e.g., specific learning modules) to transition from state to state (e.g., basic understanding of addition via a first learning module, intermediate understanding of addition via a second learning module, expert understanding of addition via a third learning module) until a target state is achieved (e.g., expert at addition). The management system can use ML models to determine the actions of agents. In addition, as the ML models, for example, become proficient in improving students' skills in one skill or subject matter (e.g., addition), that same ML model can be used to improve the students' skills in another, different skill or subject matter (e.g., multiplication).

As another example, a management system can be used for a chess match, where the management system manages the actions of the chess pieces (i.e., using agents) to achieve target states (e.g., capture the queen, corner the king, etc.) via various actions (e.g., moving the queen forward five spaces, castling, etc.). Because a given chess game setup can have a large number of states, considering each state/action can be computationally inefficient. By using hierarchical states however, the states/actions that can be used to achieve a target state can be determined much more efficiently. For instance, it can be computationally inefficient to consider moves a queen can perform if the queen has already been eliminated from the match. Furthermore, the management system can also be used, at least partially, to manage agents in scenarios outside a traditional chess match, such as Go, Checkers, and/or a chess variant (e.g., four-player chess, fog of war, etc.).

In some embodiments, a method, includes: receiving inputs associated with interactions of an agent with an environment, the interactions including a group of states associated with the environment and a group of actions associated with each state from the group of states; receiving an indication of a target state to be achieved by the agent in the environment; identifying a state sequence including a first state, a second state, and a third state from the group of states such that the agent can perform a first action to implement a transition from the first state to the second state and a second action to implement a transition from the second state to the third state in a consecutive manner; generating a hierarchical state configured to be associated with (i) a third action implementing a transition from the first state to the hierarchical state, and (ii) a fourth action implementing a transition from the hierarchical state to the third state, the first action and the second action forming an option; and setting a value associated with transition from the first state to the hierarchical state to be equal to a value combination that is a function of a value associated with the first action and a value associated with the second action, and setting a value associated with the transition from the hierarchical state to the third state to be equal to a maximum value associated with the third state.

In some implementations, the third action and the fourth action are hierarchical actions.

Some implementations further include computing the value combination; verifying that the value combination has a non-zero value; and verifying that the state sequence is non-cyclical, the generating the hierarchical state being based on the value combination having a non-zero value and the state sequence being non-cyclical.

In some implementations, the hierarchical state is associated with a value combination of values from non-hierarchical states.

Some implementations further include combining the first state the hierarchical state and the third state to generate a sequence of states associated with the third action and the fourth action, the sequence of states forming an option sequence.

Some implementations further include comparing the value combination with a threshold value, the generating the hierarchical state being based on the value combination being greater than the threshold value.

Some implementations further include receiving data associated with a performance of the agent in the environment; and modifying the threshold value based on the data associated with the performance of the agent in the environment.

Some implementations further include determining that the state sequence including the first state, the second state, and the third state to be generalizable; and discovering the hierarchical state configured to form the option, the option being configured to implement a transition from the first action to the second action in a reusable sequence.

In some implementations, the second state is associated with a first number of potential decisions to implement a transition from the first state to the third state, and the hierarchical state is associated with a second number of potential decisions to implement the transition from the first state to the third state, the method further including: discovering the hierarchical state and the option; determining that the option does not exist in an options dictionary; and forming the option in response to the determining that the option does not exist in the options dictionary.

In some implementations, the hierarchical state is a first hierarchical state the method further including: generating a second hierarchical state associated with a plurality of actions and at least two of the first state, the second state, the third state, the first hierarchical state, or a fourth state different than the first state, the second state, the third state, and the first hierarchical state.

In some embodiments, an apparatus, includes: a memory; and a hardware processor operatively coupled to the memory, the hardware processor configured to: receive inputs associated with interactions of an agent with an environment, the interactions including a group of states associated with the environment and a group of actions associated with each state from the group of states; receive an indication of a target state to be achieved by the agent in the environment by implementing a machine learning model; identify a state sequence including a first state, a second state, and a third state from the group of states such that the agent can perform a first action to implement a transition from the first state to the second state and a second action to implement a transition from the second state to the third state in a consecutive manner, at least one of the first state, the second state, or the third state being a hierarchical state and associated with a primitive action; determine an identifier associated with the hierarchical state; search a dictionary associated with the machine learning model to determine whether the identifier associated with the hierarchical state is included in the dictionary; add, based on the determination that the identifier associated with the hierarchical state is not included in the dictionary, the identifier associated with the hierarchical state to the dictionary to generate an updated dictionary; and store the updated dictionary.

In some implementations, the state that is a hierarchical state is associated with fewer actions than a state that is not a hierarchical state.

In some implementations, the second state is the hierarchical state, the hierarchical state is an abstraction of a fourth state, the hierarchical state is associated with fewer actions than the fourth state, a third action implements a transition from the first state to the fourth state, a fourth action implements a transition from the fourth state to the third state, the first action is associated with a value combination that is a function of a value associated with the third action and a value associated with the fourth action, the second action is associated with a maximum value associated with the third state.

In some implementations, the machine learning model is configured to implement a plurality of interactions between the agent and the environment, the hardware processor further configured to implement, at a first time, a first set of interactions from the group of interactions between the agent and the environment to transition from the first state to third state via the second state, the first set of interactions being associated with a first value; and implement, at a second time, a second set of interactions from the group of interactions between the agent and the environment to transition from the first state to third state via the hierarchical state, the second set of interactions being associated with a second value, the processor being further configured to add the identifier associated with the hierarchical state to the dictionary to generate the updated dictionary further based on a determination that a value combination that is a function of the first value and the second value is greater than a threshold.

In some implementations, the machine learning model is associated with a set of hyperparameters used to implement a group of interactions between the agent and the environment, the hardware processor further configured to implement, a set of interactions from the group of interactions between the agent and the environment to transition from the first state to third state via the hierarchical state, the set of interactions being associated with receiving a reward signal; and automatically adjust at least one hyperparameter from the set of hyperparameters in response to receiving the reward signal.

In some implementations, the hierarchical state is generated by merging two or more states.

In some embodiments, a non-transitory processor-readable medium stores code representing instructions to be executed by a processor. The instructions include code to cause the processor to: receive data associated with interactions between a first agent and a first environment associated with a domain; receive information about a second environment associated with the domain, the information including a goal that is desired to be achieved in the second environment; implement, using a machine learning model, a second agent configured to interact with the second environment; identify, based on the data associated with the interactions between the first agent and the first environment, a set of actions configured to be performed by the second agent while the second agent interacts with the second environment; and implement the second agent to perform an action from the set of actions, the action being configured to increase a likelihood of achieving the goal.

In some implementations, the first agent is the same as the second agent.

In some implementations, the goal is a second goal, and the first environment is implemented to perform a first task, to achieve a first goal, in the domain and the second environment is implemented to perform a second task, to achieve the second goal, in the domain.

In some implementations, the domain is at least one of financial trading, agricultural technology, or natural language processing (NLP).

In some implementations, the action is a first action, and the instructions including code to cause the processor to implement the second agent to perform the first action include code to cause the processor to implement the second agent to perform an option that includes the first action, the option including a group of actions that includes the first action, performing the option increasing the likelihood of achieving the goal and increasing an efficiency in computation associated with achieving the goal.

In some implementations, the instructions including code to cause the processor to implement the second agent to perform the action include code to cause the processor to implement the second agent to perceive the second environment to transition from a first state to a second state, the second state being a hierarchical state configured to increase the likelihood of achieving the goal and increasing an efficiency in computation associated with achieving the goal.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

1. A method, comprising:
receiving inputs associated with interactions of an agent with an environment, the interactions including a plurality of states associated with the environment and a plurality of actions associated with each state from the plurality of states;
receiving an indication of a target state to be achieved by the agent in the environment;
identifying a state sequence including a first state, a second state, and a third state from the plurality of states such that the agent can perform a first action to implement a transition from the first state to the second state and a second action to implement a transition from the second state to the third state in a consecutive manner;
generating a hierarchical state configured to be associated with (i) a third action implementing a transition from the first state to the hierarchical state, and (ii) a fourth action implementing a transition from the hierarchical state to the third state, the first action and the second action forming an option; and
setting a value associated with the transition from the first state to the hierarchical state to be equal to a value combination that is a function of a value associated with the first action and a value associated with the second action, and setting a value associated with the transition from the hierarchical state to the third state to be equal to a maximum value associated with the third state.

2. The method of claim 1, wherein the third action and the fourth action are hierarchical actions.

3. The method of claim 1, further comprising:
computing the value combination;
verifying that the value combination has a non-zero value; and
verifying that the state sequence is non-cyclical, the generating the hierarchical state being based on the value combination having a non-zero value and the state sequence being non-cyclical.

4. The method of claim 1, wherein the hierarchical state is associated with a value combination of values from non-hierarchical states.

5. The method of claim 1, further comprising:
combining the first state the hierarchical state and the third state to generate a sequence of states associated with the third action and the fourth action, the sequence of states forming an option sequence.

6. The method of claim 3, further comprising:
comparing the value combination with a threshold value, the generating the hierarchical state being based on the value combination being greater than the threshold value.

7. The method of claim 6, further comprising:
receiving data associated with a performance of the agent in the environment; and modifying the threshold value based on the data associated with the performance of the agent in the environment.

8. The method of claim 1, further comprising:
determining that the state sequence including the first state, the second state, and the third state to be generalizable; and
discovering the hierarchical state configured to form the option, the option being configured to implement a transition from the first action to the second action in a reusable sequence.

9. The method of claim 1, wherein the second state is associated with a first number of potential decisions to implement a transition from the first state to the third state, and the hierarchical state is associated with a second number of potential decisions to implement the transition from the first state to the third state, the method further comprising:
discovering the hierarchical state and the option;
determining that the option does not exist in an options dictionary; and
forming the option in response to the determining that the option does not exist in the options dictionary.

10. The method of claim 1, wherein the hierarchical state is a first hierarchical state, the method further comprising:
generating a second hierarchical state associated with a plurality of actions and at least two of the first state, the second state, the third state, the first hierarchical state, or a fourth state different than the first state, the second state, the third state, and the first hierarchical state.

11. An apparatus, comprising:
a memory; and
a hardware processor operatively coupled to the memory, the hardware processor configured to:
receive inputs associated with interactions of an agent with an environment, the interactions including a plurality of states associated with the environment and a plurality of actions associated with each state from the plurality of states;
receive an indication of a target state to be achieved by the agent in the environment by implementing a machine learning model;
identify a state sequence including a first state, a second state, and a third state from the plurality of states such that the agent can perform a first action to implement a transition from the first state to the second state and a second action to implement a transition from the second state to the third state in a consecutive manner, at least one of the first state, the second state, or the third state being a hierarchical state and associated with a primitive action;
determine an identifier associated with the hierarchical state;
search a dictionary associated with the machine learning model to determine whether the identifier associated with the hierarchical state is included in the dictionary;
add, based on the determination that the identifier associated with the hierarchical state is not included in the dictionary, the identifier associated with the hierarchical state to the dictionary to generate an updated dictionary; and
store the updated dictionary.

12. The apparatus of claim 11, wherein the state that is a hierarchical state is associated with fewer actions than a state that is not a hierarchical state.

13. The apparatus of claim 11, wherein the second state is the hierarchical state, the hierarchical state is an abstraction of a fourth state, the hierarchical state is associated with fewer actions than the fourth state, a third action implements a transition from the first state to the fourth state, a fourth action implements a transition from the fourth state to the third state, the first action is associated with a value combination that is a function of a value associated with the third action and a value associated with the fourth action, the second action is associated with a maximum value associated with the third state.

14. The apparatus of claim 11, wherein the machine learning model is configured to implement a plurality of interactions between the agent and the environment, the hardware processor further configured to
implement, at a first time, a first set of interactions from the plurality of interactions between the agent and the environment to transition from the first state to third state via the second state, the first set of interactions being associated with a first value; and
implement, at a second time, a second set of interactions from the plurality of interactions between the agent and the environment to transition from the first state to third state via the hierarchical state, the second set of interactions being associated with a second value, the processor being further configured to add the identifier associated with the hierarchical state to the dictionary to generate the updated dictionary further based on a determination that a value combination that is a function of the first value and the second value is greater than a threshold.

15. The apparatus of claim 11, wherein the machine learning model is associated with a set of hyperparameters used to implement a plurality of interactions between the agent and the environment, the hardware processor further configured to
implement, a set of interactions from the plurality of interactions between the agent and the environment to transition from the first state to third state via the hierarchical state, the set of interactions being associated with receiving a reward signal; and
automatically adjust at least one hyperparameter from the set of hyperparameters in response to receiving the reward signal.

16. The apparatus of claim 11, wherein the hierarchical state is generated by merging two or more states.

17. A non-transitory processor-readable medium storing code representing instructions to be executed by a processor, the instructions comprising code to cause the processor to:
receive data associated with interactions between a first agent and a first environment associated with a domain;
receive information about a second environment associated with the domain, the information including a goal that is desired to be achieved in the second environment;
implement, using a machine learning model, a second agent configured to interact with the second environment;
identify, based on the data associated with the interactions between the first agent and the first environment, a set of actions configured to be performed by the second agent while the second agent interacts with the second environment; and
implement the second agent to perform an action from the set of actions, the action being configured to increase a likelihood of achieving the goal.

18. The non-transitory processor-readable medium of claim 17, wherein the first agent is the same as the second agent.

19. The non-transitory processor-readable medium of claim 17, wherein the goal is a second goal, and the first environment is implemented to perform a first task, to achieve a first goal, in the domain and the second environment is implemented to perform a second task, to achieve the second goal, in the domain.

20. The non-transitory processor-readable medium of claim 19, wherein the domain is at least one of financial trading, agricultural technology, or natural language processing (NLP).

21. The non-transitory processor-readable medium of claim 17, wherein the action is a first action, and the instructions comprising code to cause the processor to implement the second agent to perform the first action include code to cause the processor to implement the second agent to perform an option that includes the first action, the option including a plurality of actions that includes the first action, performing the option increasing the likelihood of achieving the goal and increasing an efficiency in computation associated with achieving the goal.

22. The non-transitory processor-readable medium of claim 17, wherein the instructions comprising code to cause the processor to implement the second agent to perform the action include code to cause the processor to implement the second agent to perceive the second environment to transition from a first state to a second state, the second state being a hierarchical state configured to increase the likelihood of achieving the goal and increasing an efficiency in computation associated with achieving the goal.
